(19) United States
(12) Patent Application Publication
(10) Pub. No.: US 2019/0118101 A1
(43) Pub. Date: Apr. 25, 2019

(54) OBSTACLE COURSE WITH ILLUMINATED BALL PIT

(71) Applicant: MICHAEL BROWNING, JR., Grapevine, TX (US)

(72) Inventor: MICHAEL BROWNING, JR., Grapevine, TX (US)

(73) Assignee: UATP MANAGEMENT, LLC, Bedford, TX (US)

(21) Appl. No.: 16/168,202

(22) Filed: Oct. 23, 2018

Related U.S. Application Data
(60) Provisional application No. 62/576,351, filed on Oct. 24, 2017.

(51) Int. Cl. A63G 31/00; F21V 33/00

(52) U.S. Cl. CPC A63G 31/00; F21V 33/008

(57) ABSTRACT

An obstacle course has an elevated obstacle and a cushioned landing area located beneath the obstacle. The cushioned landing area has a mass of balls. The balls are at least translucent so as to transmit light. Lighting is located in the cushioned landing area and adjacent to the mass of balls so as to illuminate the mass of balls.

### FIELD OF THE INVENTION

The present invention relates to obstacle courses that people can traverse and otherwise enjoy.

### BACKGROUND OF THE INVENTION

Obstacle courses have evolved over the years. Early obstacle courses included tires that participants had to step into, walls and ropes to climb. Early obstacle courses were located outside. In recent years, obstacle courses can be found inside.

Many of the obstacles are suspended above the floor and span a space. An example of an obstacle includes monkey bars. Other obstacles include swings that the user must step onto and off of to traverse from swing to swing, inclined surfaces to climb, and zip lines. A user traverses the space and the obstacle. If the user loses grip or balance, the user may fall off the obstacle. Users are typically not wearing a safety harness. As a result, a falling user lands in the area below the obstacle.

Various surfaces have been provided underneath obstacles to cushion the fall of a user. A falling user may land on hands, feet, or other body parts, necessitating a soft surface. Examples of such surfaces include pea gravel, pools of water, foam cushions, blocks or pieces of foam and ball pits. Ball pits are pits with a large number of plastic hollow balls. The balls bear on a floor surface such as concrete.

It is desired to improve cushioned landing areas and in particular a ball pit landing area.

### SUMMARY OF THE INVENTION

An obstacle course, comprises, an elevated obstacle and a cushioned landing area located beneath the obstacle. The cushioned landing area has a mass a balls. The balls are at least translucent so as to transmit light. Lighting is located in the cushioned landing area and adjacent to the mass of balls so as to illuminate the mass of balls.

In accordance with one aspect, the mass of balls is located between the lighting and the obstacle.

In accordance with another aspect, the lighting cannot be seen directly from the obstacle.

In accordance with another aspect, the cushioned landing area further comprises a ball pit enclosure. The ball pit enclosure comprises sides that form a containment space. The mass of balls is located inside the containment space. The lighting is located inside the containment space.

In accordance with another aspect, the lighting is located on at least one of the sides of the ball pit enclosure.

In accordance with another aspect, the lighting is located on a bottom of the ball pit enclosure.

In accordance with another aspect, a foam layer is between the mass of balls and a floor.

In accordance with another aspect, the lighting is first lighting. The obstacle course further comprises second lighting located above the obstacle.

### BRIEF DESCRIPTION OF THE DRAWINGS

FIG. 1 is a perspective view of an obstacle course unit, in accordance with a preferred embodiment shown with part of the supporting structure cut away.

FIG. 2 is a cross-sectional view of the ball pit landing area, taken along liras II-II FIG. 1.

FIG. 3 is plan view of the landing area, shown without the balls.

FIG. 4 is a detail view of a light and adjacent balls, illustrating the dissemination of light through the balls.

FIG. 5 is a cross-sectional view, cut away, of the ball pit landing area, shown in accordance with another embodiment.

FIG. 6 is a plan view of the landing area, shown in accordance with still another embodiment, without the balls.

FIG. 7 is a plan view of the landing area, shown in accordance with still another embodiment, without the balls.

FIG. 8 is a cross-sectional view, cut away, of the ball pit landing area of FIG. 7.

### DESCRIPTION OF THE PREFERRED EMBODIMENT

The obstacle course has one or more obstacles that traverse spaces or spans of distance. At least, one of the obstacles is provided with a cushioned landing area that is both comfortable to land on and aesthetically pleasing. The landing area is covered with a ball pit. A user landing on the landing area lands in relative comfort on the balls. The balls are transparent or translucent. Lighting is provided so as to illuminate the balls, and the landing area, thus adding to the visual aesthetics of the obstacle. This lighting is in addition to any ambient lighting over the obstacle course. In addition, a cushioning layer is provided beneath the balls to further soften landings, and in particular landings where an arm or a leg penetrates into the balls.

The obstacle course has plural obstacle units. Each obstacle unit includes an obstacle and supporting structure for the obstacle. In addition, each obstacle unit typically includes something to allow for a user to fall safely off of the obstacle. For example, a landing area is located below the obstacle and allows a user to fall from the obstacle and land safely and without injury. As another example, some obstacles may provide harnesses that a user wears when traversing the obstacle. If the user falls, the harness suspends the user above the floor, preventing injury.

Each obstacle unit, also has locations where a user can enter the obstacle unit and leave the obstacle unit. Typically, the course is set up so that a user traverses one obstacle and when leaving that obstacle is positioned so as to traverse the next obstacle. The obstacles are typically arranged so that a user traverses the obstacles in a predetermined sequence. An obstacle unit ma share supporting structure and a landing area with adjacent obstacle units.

The obstacle course can be indoors or outside. If indoors, the course is located on an underlying floor structure, such as concrete. If outdoors, the course is located on ground. Ambient lighting is provided, which lighting is above the landing area and above the obstacle course. If indoors, the ambient lighting is typically located along the ceiling. If outdoors, the ambient lighting is typically daylight, supplemented with pole mounted lighting for night operations.

The obstacle course can be on a single level or on plural levels. If on a single level, each unit is located adjacent to the ground. If on plural levels, some units are adjacent to the ground while other units are elevated above the ground. Some of the elevated units may provide a landing area and thus provide a supporting floor structure. The supporting floor structure is elevated above the ground.

For the discussion herein, the term “floor” will be used to describe the floor, ground or other underlying (elevated or not) structure. In the description, like reference numbers show like components among the figures.

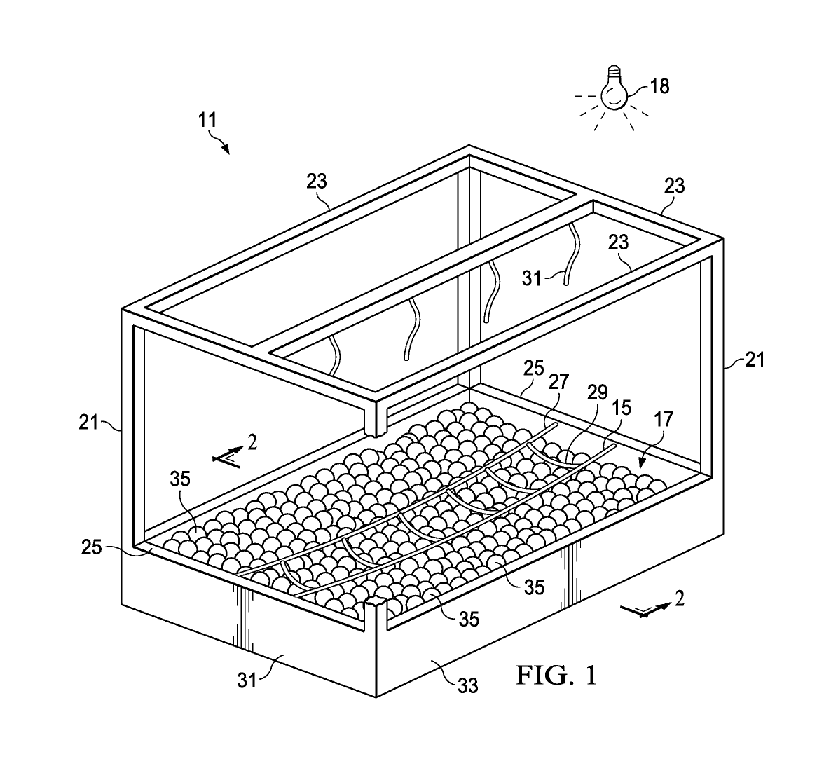

FIG. 1 shows an exemplary obstacle unit 11. The obstacle unit includes the obstacle 15, supporting structure located around the obstacle and a landing area 17 below the obstacle. Ambient lighting 18 is located above the obstacle course.

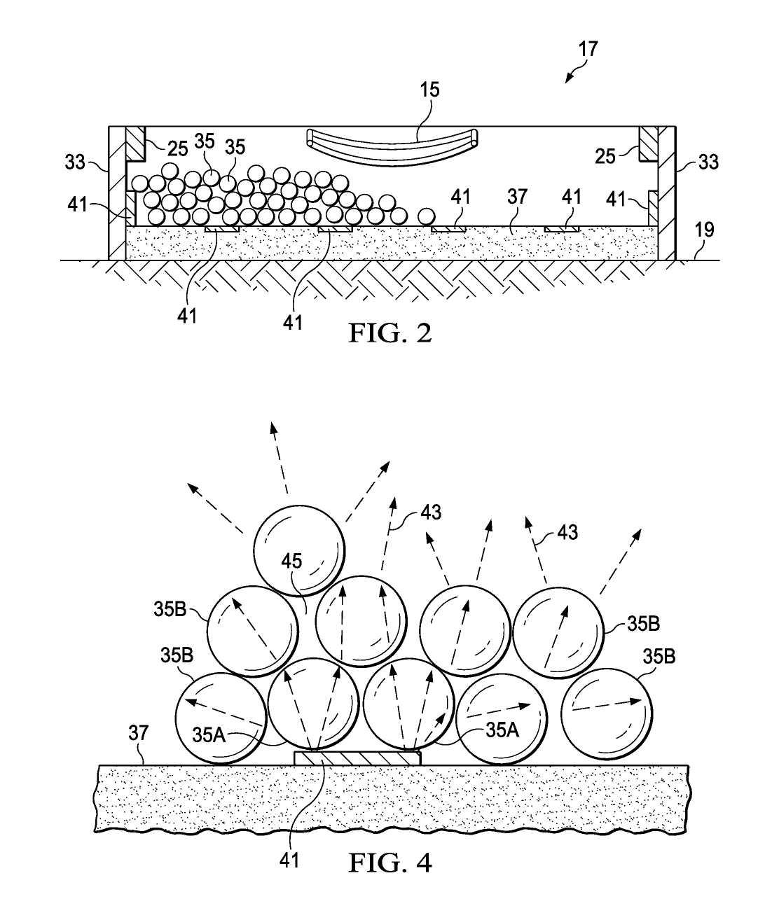

The obstacle 15 is elevated above the floor 19 (see also FIG. 2). The obstacle may be supported above the floor by the supporting structure. Alternatively, the obstacle may be supported directly by the floor.

The supporting structure includes vertical posts 21 and overhead beams 23 supported by the posts. In FIG. 1, the frontmost post 21 is cut away so as to better view the obstacle 15. In addition, lateral beams 25 may be provided between the posts, at a lower level. The posts 21 and beams 25 are covered with cushions to provide soft surfaces against impact. Alternatively, the obstacle can be supported directly by the floor.

An example of an obstacle 15 includes a rope or cable ladder oriented horizontally (shown, in FIG. 1). The ladder has rope rails 27, the ends of which are secured to the lateral beams 25; the ladder spans from one lateral beam to another. Rope steps 29 extend between the rails. The ladder is elevated above the floor 19 and above the landing area 17. Other types of ladders can be used, such as ladders having steps made of boards or logs. Such ladders exhibit movement when a user attempts to cross, increasing the level of difficulty. Ropes 31 or other handholds can be suspended over the rope ladder, for users to grasp when crossing the ladder.

Another example of an obstacle includes a zip line having a line spanning the unit, with a trolley thereon. The user grasps the trolley and rides across the unit. The zip line may be a cable or pipe. The zip line may be sloped downwardly so the user can utilize gravity. Alternatively, the zip line may be horizontal, wherein the user must swing the user's body to develop the momentum needed to move along the zip line.

Another example of an obstacle includes one or more narrow beams oriented horizontally. The user must maintain balance while stepping on the top surface of the beam. The beam can be fixed or the beam can pivot about a point along its length so that the ends move up and down. With the pivoting beam, the beam end is down when the use steps on that end, with the far end raised to an up position. The pivot point for the beam can be located in the landing area 17.

Another example of an obstacle includes several swings arranged in a row. Each swing has a seat suspended by ropes. The user steps on the nearest swing and then the next swing and so on.

Another example of an obstacle includes a path of stepping areas elevated above the floor. The stepping areas can be flat or nonflat and are spaced apart from one another. The user steps on each stepping area. The stepping areas are typically small in area to require the user to maintain balance. The stepping areas can be mounted to the floor or to a beam suspended by the lateral beams. The stepping areas can be fixed in place or movable.

The landing area 17 is located below the obstacle 15 and above the floor 19. The landing area includes, a ball pit. The ball pit has end wails 31 and side walls 33 to form a pit or containment space. The end and side walls 31, 33 may be under the lateral beams 25. The walls 31, 33 can be made of foam covered with a material such as vinyl. Such walls are self-standing. The bottom edges of the walls can be coupled to a bottom layer, which anchors the bottom edges.

Balls 35 are located inside the walls 31, 33 or pit area. The balls from a mass that covers the entire landing area. The mass of balls extends between and contacts the end walls 31 and the side walls 33. The mass of balls 35 extends to a depth so that balls are stacked on top of other balls. For example, the balls can be stacked to a depth of 1-4 feet. (The figures show only a few balls for illustrative purposes.)

The balls 35 are hollow spheres with walls typically made of plastic. Plastic typically does not break under normal use. The balls are several inches in diameter, ranging for example from 2 inches to 5 inches. The balls are typically of a uniform diameter; however the balls can be of different diameters.

The walls of the balls 35 are at least translucent so as to pass light therethrough. The use of the term “at least translucent” means either translucent or transparent and light is allowed to pass though. An opaque wall blocks the passage of light therethrough and is therefore not translucent (and certainly not transparent). In the preferred embodiment, the balls are transparent. The balls need not be perfect spheres, but can exhibit some misshaping. In addition, the walls making up the balls may contain imperfections (for example air bubbles, occlusions, etc.) in the transparency or translucency. The interiors of the balls are empty, being filled with air.

The balls can be made in several ways. One way is injection molding of two spherical halves. The halves are removed from the molds and then assembled into a ball. The halves are then coupled together, such as by heat welding. Another way is to rotationally mold the balls.

In the prior art, balls in ball pits are made of opaque plastic, not transparent or translucent plastic. In the prior art, aesthetic appearance is achieved by having the balls be brightly colored. The balls in the prior art ball pits are illuminated by lighting above the ball pit, such as by ceiling lights. Such ceiling lights are common in indoor buildings housing obstacle courses.

A layer of foam 37 or some other cushioning material is provided underneath the balls. The foam is above the floor 19 and forms the bottom of the ball pit. The bottom balls contact the foam. A user may fall from the obstacle and land in the landing area, pushing an arm or leg through the bails toward the floor. The foam forms a barrier so the user does not directly contact the floor, and further softens the landing. The foam can he uncovered, where the bottom balls contact the foam directly. Alternatively, the foam can be covered with a material such as vinyl.

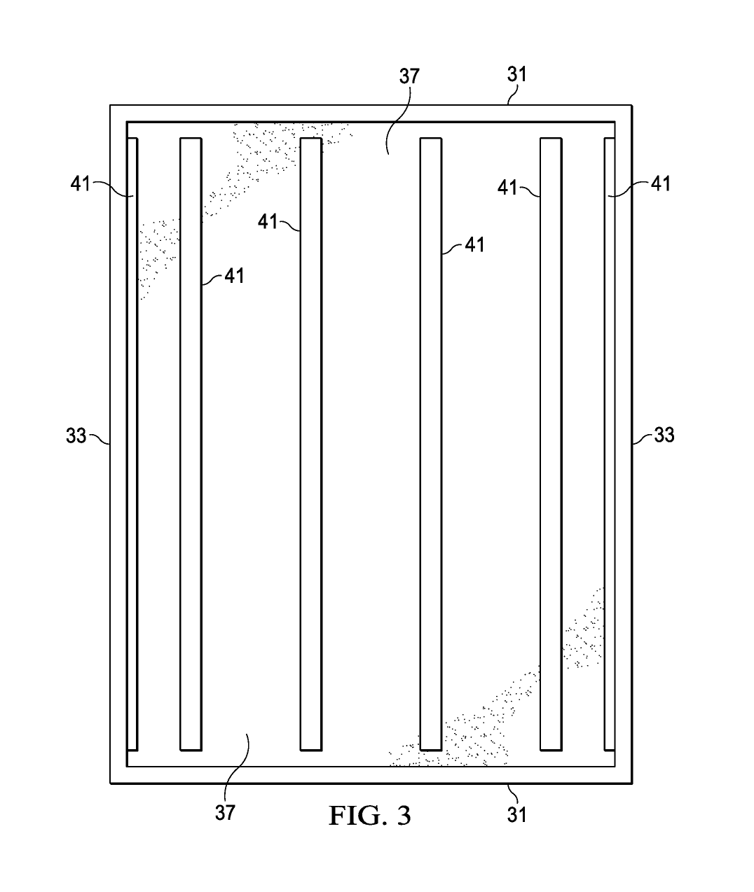

The ball pit is provided with lighting 41, or light sources, underneath the mass of bails 35. The lighting illuminates the balls. In one embodiment, the lighting 41 includes LED strips (see FIGS. 2 and 3). Such LED strips 41 have plural individual LEDs arranged along the strip. The strip forms a hacking for the LEDs and associated wiring to connect the LEDs. The strips are flexible and are located on the foam layer. The strips have a low profile and do not interfere with the operation of the balls in cushioning a landing. The LED strips extend from one wall to the opposite wall. Plural strips are provided, with the strips spaced apart from each other. The strips can extend between the side walls or between the end walls. In addition, strips can be located on the side walls 33, or on the end walls 31. The lighting strips are provided with the necessary electrical power to operate.

The strips 41 can be located in recesses formed in the top of the foam layer 37 (see FIG. 2). As an alternative, the strips can be located on top of the foam layer (see FIG. 4).

Other types of lighting can be provided. For example, the lighting can include individual lights spaced apart from one another. Lighting can also be provided on the side and end walls, as shown in FIGS. 2 and 3.

The mass of balls 35 cover or obscure the lighting 41 from direct view of the users. Thus, the mass of balls overlay the lighting.

When the lighting 41 is illuminated, the balls 35 illuminate. Even though the balls obscure the lighting from direct view, the balls act as lenses (see FIG. 4), with the balls illuminating and transmitting light 43 to adjacent balls and to the space above the landing area where users can view the light. In particular, the balls 35A adjacent to a light 41 are illuminated by the light. Those illuminated balls pass some of the light on to next adjacent balls 35B, which in turn pass the light on the next adjacent balls and so on. The adjacent balls maybe in direct physical contact with the source ball, or may be in near proximity thereto. The light is transmitted from ball to ball at the points where the balls make direct contact with each other. The light is also transmitted across air gaps 45 between the balls. Because the balls are spherical, each ball is mostly surrounded by air gaps; the areas of contact with adjoining balls are small in size. The balls transmit the light in all directions. Thus, a user above and to the side of the landing area can view the illuminated balls. Each entire ball appears to be illuminated by the light

A user attempts to cross the obstacle 15. The user starts at one end of the unit, steps onto a ladder rung and attempts to walk across on the rungs. The user can grasp the ropes 31 for assistance. As the user approaches and negotiates the obstacle, the user sees the illuminated balls in the ball pit below. The aesthetic effect is unique as prior art landing areas lack such lighting.

If the user falls into the landing area, the user displaces some of the balls. The balls move in response to the impact and cushion the fall. This displacement is enhanced visually by the illuminated balls. The illuminated balls are easily seen even with ambient overhead lighting. Such ambient overhead lighting typically is ceiling lights located above the obstacle unit. The space around the obstacle unit need not be darkened for the illumination in the balls to be seen.

The spacing of the light strips can vary. Preferably, the light strips are spaced sufficiently close to avoid dark, or poorly illuminated areas of balls in the ball pit.

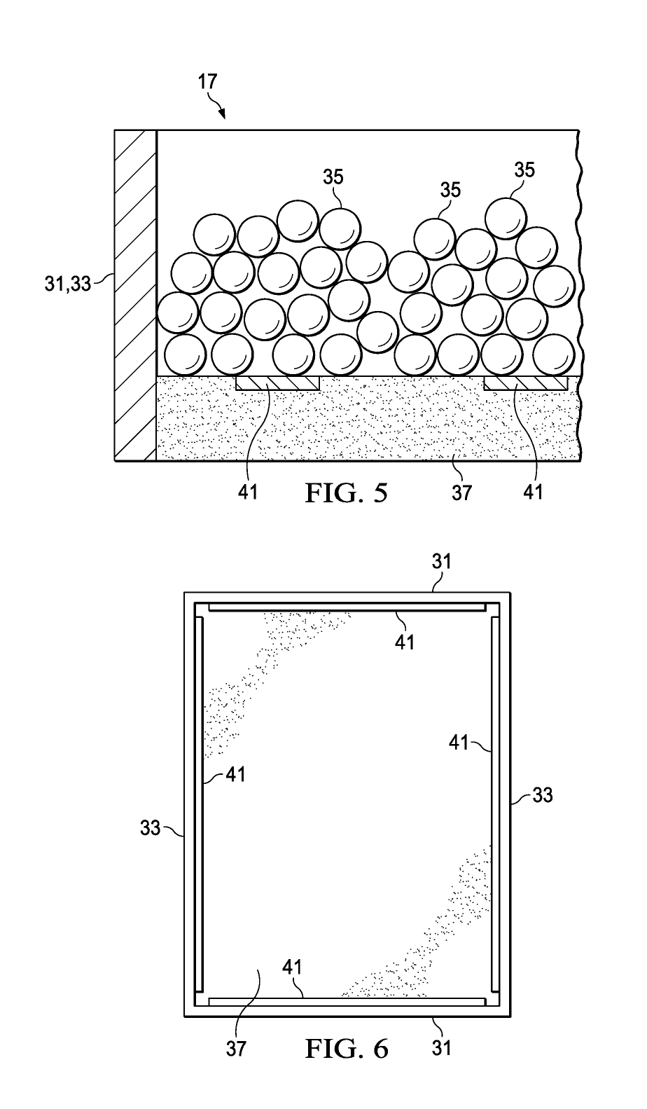

FIGS. 5 and 6 illustrate other embodiments of lighting configurations. In FIG. 5, the lights 41 are located on the bottom 37, or floor, of the ball pit, with no lights on the walls 31, 33. In FIG. 6, the lights are located on the walls 31, 33, but not on the bottom 37. In FIGS. 5 and 6, the bottom is made up of the foam 37.

Thus, the lights can be located in various ways in the ball pit. The lights can be located on the bottom 37, on the walls 31, 33, or a combination of on the bottom and the walls. Lights located on the bottom can be located on top of the foam or in the foam.

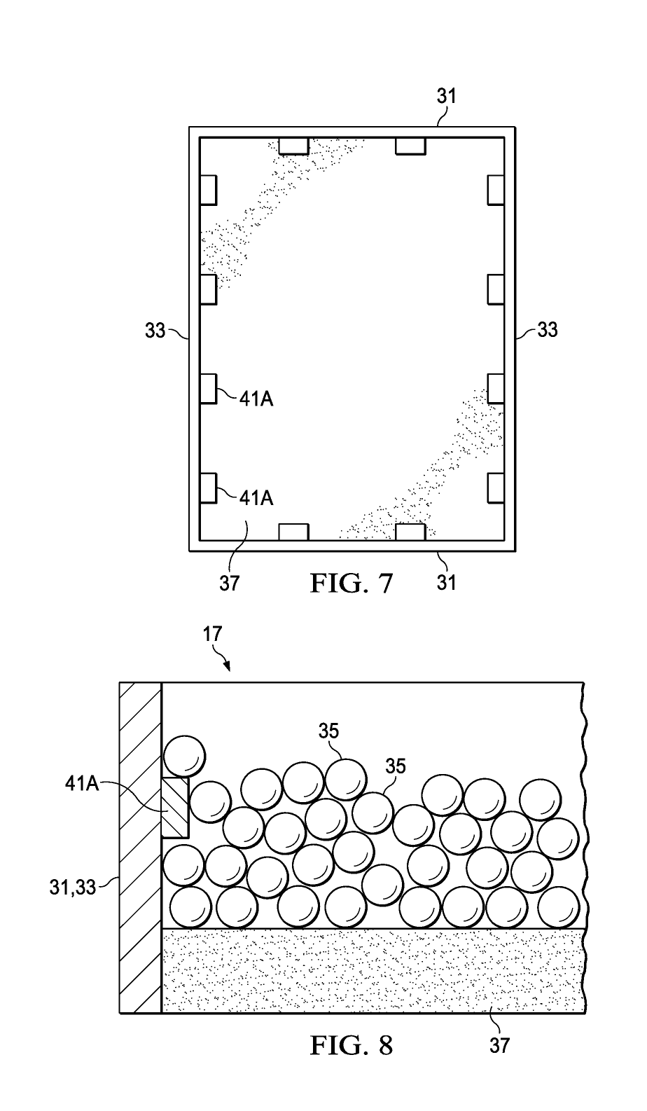

FIGS. 7 and 8 illustrate still another embodiment of the lighting configuration. The lights 41A are of the LED type, but instead of strip lights, are non-strip light fixtures. For example, wash lights 41A can be used. Such wash lights are provided with a housing and one or more LED lights. For example, the housing can be disc or can shaped. Mounting hardware can be provided to mount the lights to the walls. For example, a mounting bracket can be used to mount each light fixture 41A to the respective wall. The wall is sturdy enough to support the light.

The lights 41A are located around the periphery of the ball pit, with lights on the side walls 33 and the end walls 31. The lights 41A are located so as to be underneath the balls.

The lighting can be white light or have one or more colors. The walls of the balls can be clear so that the balls appear as white (if white lighting is used). Alternatively, the walls of the balls can have color tints, so that the balls appear colored (for example, blue). The lights can change colors.

Although the lighting has been described as being used in conjunction with a foam layer, the lighting can be used without foam. The bottom of the ball pit would be the floor 19 or some other material.

The foregoing disclosure and showings made in the drawings are merely illustrative of the principles of this invention and are not to be interpreted in a limiting sense.

1. An obstacle course, comprising:
a) an elevated obstacle;
b) a cushioned landing area located beneath the obstacle, the cushioned landing area having a mass of balls, the balls being at least translucent so as to transmit light;
d) lighting located in the cushioned landing area and adjacent to the mass of balls so as to illuminate the mass of balls.

2. The obstacle course of claim 1, wherein the mass of balls is located between the lighting and the obstacle.

3. The obstacle course of claim 2, wherein, the lighting cannot be seen directly from the obstacle.

4. The obstacle course of claim 1, wherein the cushioned landing area further comprises a ball pit enclosure, the ball pit enclosure comprising sides that form a containment space, the mass of balls located inside the containment space, the lighting located inside the containment space.

5. The obstacle course of claim 4, wherein the lighting is located on at least one of the sides of the ball pit enclosure.

6. The obstacle course of claim 4, wherein the lighting is located on a bottom of the ball pit enclosure.

7. The obstacle course of claim 4, further comprising a foam layer between the mass of balls and a floor.

8. The obstacle course of claim 1, wherein the lighting is first lighting, the obstacle course further comprising second lighting located above the obstacle.
